(19) United States
(12) Patent Application Publication
(10) Pub. No.: US 2018/0009375 A1
(43) Pub. Date: Jan. 11, 2018

(54) Vehicular Safety Alert Assembly

(71) Applicant: Jerry Miles, Ijamsville, MD (US)

(72) Inventor: Jerry Miles, Ijamsville, MD (US)

(21) Appl. No.: 15/205,486

(22) Filed: Jul. 8, 2016

(51) Int. Cl. B60Q 1/52; B60R 16/033; B60Q 9/00; H04W 4/00; B60N 2/00

(52) U.S. Cl. CPC B60Q 1/52; H04W 4/008; B60N 2/002; B60Q 9/00; B60R 16/033

(57) ABSTRACT

A vehicular safety alert assembly includes a first sensing unit that may be positioned on a driver's seat in a vehicle. Thus, the first sensing unit may detect when a driver sits in the driver's seat. The first sensing unit is in electrical communication with the vehicle's alarm system. A second sensing unit may be positioned on a child seat in the vehicle. Thus, the second sensing unit may detect when a child is sitting in the child seat. The second sensing unit is electrically coupled to the first sensing unit. The first sensing unit generates an alarm sequence when the second sensing unit detects the child and the first sensing unit does not detect the driver. The vehicle's alarm system emits an audible alarm when the alarm sequence is generated. Thus, the driver is alerted that the child is unattended in the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to alert devices and more particularly pertains to a new alert device for generating an alarm when a child is left unattended in a vehicle.

### BRIEF SUMMARY OF THE INVENTION

An embodiment of the disclosure meets the needs presented above by generally comprising a first sensing unit that may be positioned on a driver's seat in a vehicle. Thus, the first sensing unit may detect when a driver sits in the driver's seat. The first sensing unit is in electrical communication with the vehicle's alarm system. A second sensing unit may be positioned on a child seat in the vehicle. Thus, the second sensing unit may detect when a child is sitting in the child seat. The second sensing unit is electrically coupled to the first sensing unit. The first sensing unit generates an alarm sequence when the second sensing unit detects the child and the first sensing unit does not detect the driver. The vehicle's alarm system emits an audible alarm when the alarm sequence is generated. Thus, the driver is alerted that the child is unattended in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicular safety alert assembly according to an embodiment of the disclosure.

FIG. 2 is a bottom phantom view of an embodiment of the disclosure.

FIG. 3 is a perspective in-use view of an embodiment of the disclosure.

FIG. 4 is a schematic view of an embodiment of the disclosure.

### DETAILED DESCRIPTION OF THE INVENTION

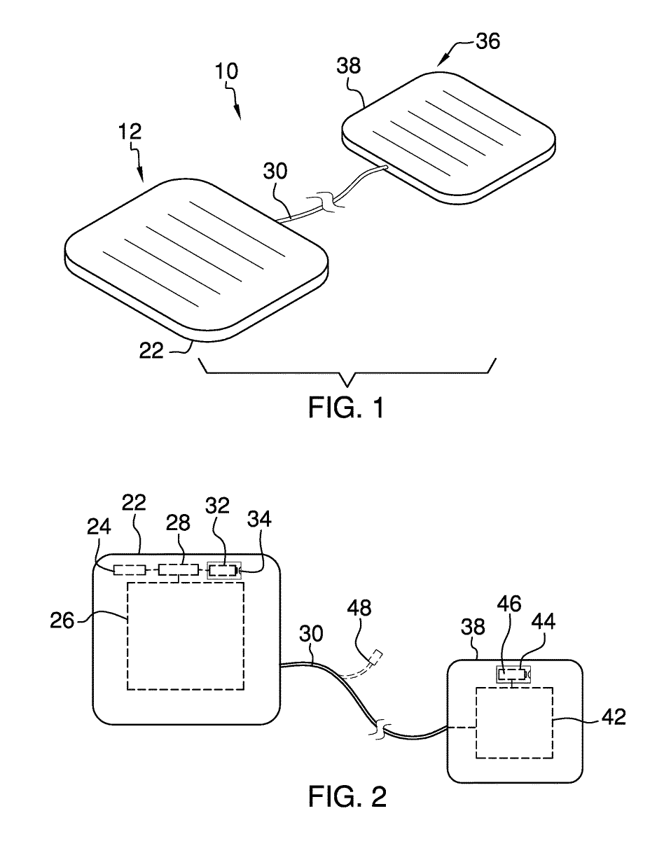

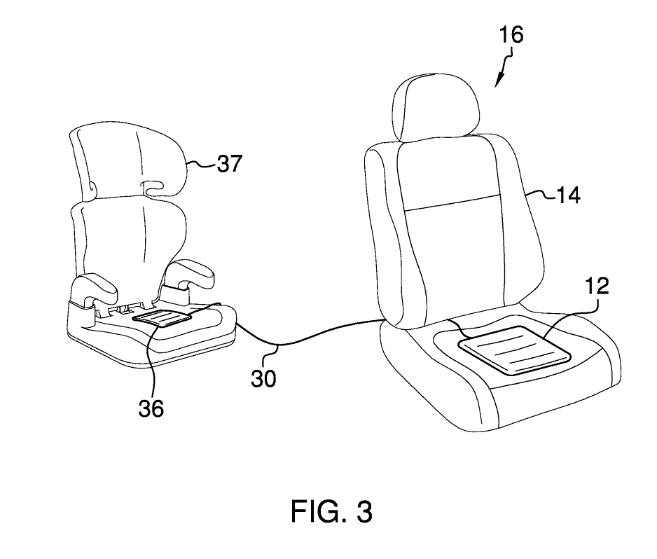

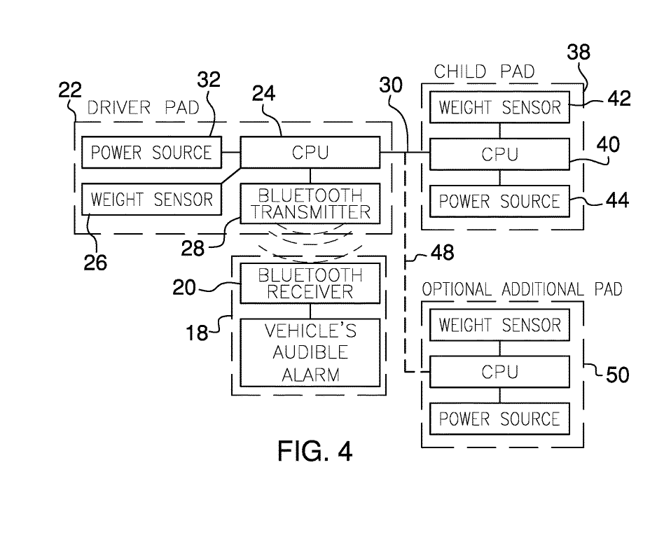

With reference now to the drawings, and in particular to FIGS. 1 through 4 thereof, a new alert device embodying the principles and concepts of an embodiment of the disclosure and generally designated by the reference numeral 10 will be described.

As best illustrated in FIGS. 1 through 4, the vehicular safety alert assembly 10 generally comprises a first sensing unit 12. The first sensing unit 12 may be positioned on a driver's seat 14 in a vehicle 16. Thus, the first sensing unit 12 may detect when a driver sits in the driver's seat 14. The vehicle 16 may be a passenger vehicle 16 or the like.

The first sensing unit 12 selectively generates an alarm sequence. The first sensing unit 12 is in electrical communication with the vehicle's alarm system 18. The vehicle's alarm system 18 may include a transceiver 20. The transceiver 20 may be a radio frequency transceiver 20 or the like. Moreover, the transceiver 20 may be a Bluetooth transceiver 20 that uses a WPAN signal or the like. The vehicle's alarm system 18 may additionally include an audio system in the vehicle 16.

The first sensing unit 12 comprises a first pad 22 that may be positioned on the driver's seat 14. A first processor 24 is positioned within the first pad 22. Moreover, the first processor 24 selectively generates the alarm sequence. The first processor 24 may comprise an electronic processor or the like.

A first weight sensor 26 is provided and the first weight sensor 26 is positioned within the first pad 22. The first weight sensor 26 detects a weight of the driver. Thus, the first weight sensor 26 detects when the driver sits on the first pad 22. The first weight sensor 26 may be an electronic weight sensor or the like. The first weight sensor 26 is electrically coupled to the first processor 24. The first weight sensor 26 may have a trigger weight ranging between thirty five kg and one hundred thirty five kg.

A transmitter 28 is provided and the transmitter 28 is positioned within the first pad 22. The transmitter 28 is electrically coupled to the first processor 24. The transmitter 28 is in wireless communication with the vehicle's electrical system. The transmitter 28 may comprise a radio frequency transmitter 28 or the like. Additionally, the transmitter 28 may be Bluetooth transmitter 28 that uses a WPAN signal or the like.

A conductor 30 is coupled to and extends outwardly from the first pad 22. The conductor 30 is electrically coupled to the first processor 24. The conductor 30 may have a length ranging between one meter and three meters. A first power supply 32 is positioned within the first pad 22. The first power supply 32 is electrically coupled to the first processor 24. The first power supply 32 comprises at least one battery 34.

A second sensing unit 36 is provided. The second sensing unit 36 may be positioned on a child seat 37 in the vehicle 16. Thus, the second sensing unit 36 detects when a child is sitting on the second pad 38. The child seat 37 may be a child car seat or the like. Alternatively, the second sensing unit 36 may be positioned on a back seat of the vehicle 16.

The second sensing unit 36 is electrically coupled to the first sensing unit 12. The first sensing unit 12 generates a first alarm condition when the first sensing unit 12 does not detect the driver. The second sensing unit 36 generates a second alarm condition when the second sensing unit 36 detects the child. The first sensing unit 12 generates the alarm sequence when the first alarm condition and the second alarm condition are generated. The vehicle's alarm system 18 is actuated to emit an audible alarm when the alarm sequence is generated. Thus, the driver is alerted that the child is unattended in the vehicle 16.

The second sensing unit 36 comprises a second pad 38. The second pad 38 may be positioned on the child seat 37. A second processor 40 is positioned within the second pad 38. The second processor 40 may be an electronic processor or the like.

A second weight sensor 42 is positioned within the second pad 38. The second weight detector detects a weight of the child. Thus, the second weight sensor 42 may detect when the child sits on the second pad 38. The second weight sensor 42 is electrically coupled to the second processor 40. The second weight sensor 42 may be an electronic weight sensor or the like. Moreover, the second weight sensor 42 may have a trigger weight ranging between four kg and twenty kg.

The conductor 30 is coupled to and extends outwardly from the second pad 38. The conductor 30 is electrically coupled to the second processor 40. Thus, the second processor 40 is in electrical communication with the first processor 24. The conductor 30 is selectively routed between the driver's seat 14 and the child seat 37. The conductor 30 may be an insulated electrical wire or the like.

A second power supply 44 is provided. The second power supply 44 is positioned within the second pad 38. The second power supply 44 is electrically coupled to the second processor 40. The second power supply 44 comprises at least one battery 46.

A secondary extension 48 may be electrically coupled to the conductor 30. The secondary extension 48 may include a power plug or the like. A third sensing unit 50 may be provided. The third sensing unit 50 may be selectively electrically coupled to the secondary extension 48. The third sensing unit 50 may be positioned at a selected location within the vehicle 16.

In use, the first pad 22 is positioned on the driver's seat 14 and the second pad 38 is positioned on the child seat 37. The transmitter 28 is wirelessly synched with the vehicle 16 alarm through any conventional means. The first weight sensor 26 detects when the driver sits in the driver's seat 14. The second weight sensor 42 detects when the child sits in the child seat 37.

The vehicle's alarm system 18 emits the audible alarm when the driver leaves the driver's seat 14 while the child is seated in the child seat 37. Thus, the driver is reminded that the child is seated in the child seat 37 thereby inhibiting the driver from leaving the child in the vehicle 16. The audible alarm reduces the possibility of injury to the child resulting from excessive heat in the vehicle 16 or the like. The vehicle's alarm system 18 is turned off when the child is removed from the child seat 37.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicular safety alert assembly being configured to alert a driver that a child is unattended in a vehicle, said assembly comprising:
a first sensing unit being configured to be positioned on a driver's seat in a vehicle wherein said first sensing unit is configured to detect when a driver sits in the driver's seat, said first sensing unit selectively generating an alarm sequence, said first sensing unit being configured to be in electrical communication with the vehicle's alarm system, said first sensing unit comprises:
a first pad being configured to be positioned on the driver's seat; and
a first processor being positioned within said first pad, said first processor selectively generating said alarm sequence;
a second sensing unit being configured to be positioned on a child seat in the vehicle wherein said second sensing unit is configured to detect when a child is sitting in the child seat, said second sensing unit being electrically coupled to said first sensing unit, said first sensing unit generating said alarm sequence when said second sensing unit detects the child is sitting in the child seat and said first sensing unit does not detect the driver is sitting in the driver's seat wherein the vehicle's alarm system is configured to emit an audible alarm thereby facilitating the driver to be alerted that the child is unattended in the vehicle;
a conductor being coupled to and extending outwardly from said first pad, said conductor being electrically coupled to said first processor;
an extension electrically coupled to said conductor, said extension including a plug; and
a third sensing unit electrically coupled to said extension through said plug.

2. (canceled) The assembly according to claim 1, wherein said first sensing unit comprises:
a first pad being configured to be positioned on the driver's seat; and
a first processor being positioned within said first pad, said first processor selectively generating said alarm sequence.

3. The assembly according to claim 1, further comprising a first weight sensor being positioned within said first pad wherein said first weight sensor is configured to detect when the driver sits on said first pad, said first weight sensor being electrically coupled to said first processor.

4. The assembly according to claim 1, further comprising a transmitter being positioned within said first pad, said transmitter being electrically coupled to said first processor, said transmitter being configured to be in wireless communication with the vehicle's electrical system.

5. (canceled)

6. The assembly according to claim 1, further comprising a first power supply being positioned within said first pad, said first power supply being electrically coupled to said first processor, said first power supply comprising at least one battery.

7. The assembly according to claim 1, wherein said second sensing unit comprises:
a second pad being configured to be positioned on the child seat; and
a second processor being positioned within said second pad.

8. The assembly according to claim 7, further comprising a second weight sensor being positioned within said second pad wherein said second weight sensor is configured to detect when the child sits on said second pad, said second weight sensor being electrically coupled to said second processor.

9. The assembly according to claim 7, further comprising said conductor being coupled to and extending outwardly from said second pad, said conductor being electrically coupled to said second processor such that said second processor is in electrical communication with said first processor.

10. The assembly according to claim 7, further comprising a second power supply being positioned within said second pad, said second power supply being electrically coupled to said second processor, said second power supply comprising at least one battery.

11. A vehicular safety alert assembly being configured to alert a driver that a child is unattended in a vehicle, said assembly comprising:
a first sensing unit being configured to be positioned on a driver's seat in a vehicle wherein said first sensing unit is configured to detect when a driver sits in the driver's seat, said first sensing unit selectively generating an alarm sequence, said first sensing unit being configured to be in electrical communication with the vehicle's alarm system, said first sensing unit comprising:
a first pad being configured to be positioned on the driver's seat,
a first processor being positioned within said first pad, said first processor selectively generating said alarm sequence,
a first weight sensor being positioned within said first pad wherein said first weight sensor is configured to detect when the driver sits on said first pad, said first weight sensor being electrically coupled to said first processor,
a transmitter being positioned within said first pad, said transmitter being electrically coupled to said first processor, said transmitter being configured to be in wireless communication with the vehicle's electrical system,
a conductor being coupled to and extending outwardly from said first pad, said conductor being electrically coupled to said first processor, and
a first power supply being positioned within said first pad, said first power supply being electrically coupled to said first processor, said first power supply comprising at least one battery;
a second sensing unit being configured to be positioned on a child seat in the vehicle wherein said second sensing unit is configured to detect when a child is sitting in the child seat, said second sensing unit being electrically coupled to said first sensing unit, said first sensing unit generating said alarm sequence when said second sensing unit detects the child is sitting in the child seat and said first sensing unit does not detect the driver is sitting in the driver's seat wherein the vehicle's alarm system is configured to emit an audible alarm thereby facilitating the driver to be alerted that the child is unattended in the vehicle, said second sensing unit comprising:
a second pad being configured to be positioned on the child seat,
a second processor being positioned within said second pad,
a second weight sensor being positioned within said second pad wherein said second weight sensor is configured to detect when the child sits on said second pad, said second weight sensor being electrically coupled to said second processor,
said conductor being coupled to and extending outwardly from said second pad, said conductor being electrically coupled to said second processor such that said second processor is in electrical communication with said first processor, and
a second power supply being positioned within said second pad, said second power supply being electrically coupled to said second processor, said second power supply comprising at least one battery;
an extension electrically coupled to said conductor, said extension including a plug; and
a third sensing unit electrically coupled to said extension through said plug.
